(19) United States
(12) Patent Application Publication
(10) Pub. No.: US 2026/0257516 A1
(43) Pub. Date: Sep. 3, 2026

(54) Optimized Architecture of a Civil Engineering Tire

(71) Applicant: COMPAGNIE GENERALE DES ETABLISSEMENTS MICHELIN, Clermont-Ferrand (FR)

(72) Inventor: Emmanuel CLEMENT, Clermont-Ferrand Cedex 9 (FR)

(21) Appl. No.: 18/877,617

(22) PCT Filed: Jun. 13, 2023
(86) PCT No.: PCT/EP2023/065753

§ 371 Date: Dec. 20, 2024

(30) Foreign Application Priority Data
Jun. 20, 2022 (FR) FR2206025

(51) Int. Cl. B60C 9/22; B60C 9/20

(52) U.S. Cl. CPC B60C 9/2006; B60C 9/22; B60C 2009/2012; B60C 2009/2025; B60C 2009/2029; B60C 2009/2038; B60C 2009/2041; B60C 2009/208; B60C 2009/2219; B60C 2009/2223

(57) ABSTRACT

Tire (1) of construction plant type, having a first working layer, of width L1, with metal reinforcers of angle A1, second and third working layers of widths L2 and L3, centred over the widths L21 and L31 metal reinforcers of angles A12 and A13, and having, on either side of the median plane, axially on the outside of L21 and L23, second elastic metal reinforcers of angles A22 and A23 less than 8°. The tire has two radially outermost protective layers (31), of axial widths LPN1 and LPN2, with elastic reinforcers of angles APN1 and APN2. The absolute values of the angles A1, A21, A31, APN1, APN2 are greater than 20°. A1 and A31 have the same sign, this being the opposite sign to the angle A21. The width L1 is greater than the widths L2 and L3 and less than one of the widths LPN1, LPN2.

The subject of the present invention is a radial tire, intended to be fitted to a heavy-duty vehicle of construction plant type, and the invention relates more particularly to the crown reinforcement of such a tire.

Radial tires intended to be fitted to a heavy-duty vehicle of construction plant type are designated within the meaning of the European Tire and Rim Technical Organisation, or ERTRO, standard.

For example, a radial tire for a heavy-duty vehicle of construction plant type, within the meaning of the European Tire and Rim Technical Organisation, or ETRTO, standard, is intended to be mounted on a rim with a diameter at least equal to 25 inches. Although not limited to this type of application, the invention is described for a radial tire of large size, which is intended to be mounted on a dumper, in particular on vehicles for transporting materials extracted from quarries or surface mines, by way of a rim with a diameter at least equal to 35 inches, possibly as much as 57 inches, or even 63 inches.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to the axis of rotation of the tire” and “further away from the axis of rotation of the tire”, respectively. “Axially inner/axially on the inside” and “axially outer/axially on the outside” mean “closer to the equatorial plane of the tire” and “further away from the equatorial plane of the tire”, respectively, with the equatorial plane of the tire being the plane that passes through the middle of the tread surface and is perpendicular to the axis of rotation. “An element A axially on the inside of an element B by an axial distance D” is understood to mean that the element A is closer to the equatorial plane than the element B is and that the axial distance between the two elements is equal to the distance D. This type of phrase can be extended to the radial and the circumferential direction and the outer position versus the inner position of one or the other of the elements.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire also comprises a reinforcement made up of a crown reinforcement radially on the inside of the tread and of a carcass reinforcement radially on the inside of the crown reinforcement.

The carcass reinforcement of a radial tire for a heavy-duty vehicle of construction plant type usually comprises at least one carcass layer comprising metal reinforcers that are coated in a polymeric material of the elastomer or elastomeric type that is obtained by blending and is known as a coating compound. A carcass layer comprises a main part, joining the two beads together and generally wrapped, in each bead, from the inside to the outside of the tire around a generally metal circumferential reinforcing element known as a bead wire so as to form a turn-up. The metal reinforcers of a carcass layer are substantially parallel to one another and form an angle of between 85° and 95° with the circumferential direction.

The crown reinforcement of a radial tire for a vehicle of construction plant type comprises a superposition of crown layers extending circumferentially, radially on the outside of the carcass reinforcement. Each crown layer is made up of generally metal reinforcers that are parallel to one another and coated in a polymeric material of the elastomer or coating compound type.

A metal reinforcer is mechanically characterized by a curve representing the tensile force (in N) applied to the metal reinforcer as a function of its relative elongation (in %), known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ASTM D 2969-04 of 2014.

The total elongation At of the metal reinforcer is, by definition, the sum of its elastic and plastic structural elongations (At=As+Ae+Ap), in particular at break where each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behaviour of the metal following Hooke's law. The plastic elongation Ap results from the plasticity, i.e. the irreversible deformation beyond the yield point, of the metal of these metal threads taken individually. These various elongations and the respective meanings thereof, which are well known to a person skilled in the art, are described, for example, in the documents U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between elastic metal reinforcers, such as those used in the protective layers, and non-extensible or inextensible metal reinforcers.

An elastic metal reinforcer, in its rubberized state and extracted from the tire, is characterized by a structural elongation As at least equal to 0.3% and a total elongation at break At at least equal to 3%. Moreover, an elastic metal reinforcer has a tensile elastic modulus at most equal to 150 GPa, and usually between 40 GPa and 110 GPa.

An inextensible metal reinforcer is characterized by a total elongation At, under a tensile force equal to 10% of the force at break Fm, at most equal to 2%. Moreover, a non-extensible metal reinforcer has a tensile elastic modulus usually between 150 GPa and 200 GPa.

Among the crown layers, a distinction is usually made between the protective layers, which make up the protective reinforcement, are radially outermost and comprise elastic reinforcing elements (or reinforcers), and the working layers, which comprise reinforcing elements that make up the working reinforcement and are radially comprised between the protective reinforcement and the carcass reinforcement. The angles of the reinforcing elements of the protective layers, or their elasticity, which is relatively greater than that of the reinforcing elements of the working layers, are such that the protective layers only absorb very little load caused by running in comparison with the working layers.

The protective reinforcement, comprising at least one protective layer, essentially protects the working layers from mechanical or physicochemical attacks that are liable to spread through the tread radially towards the inside of the tire.

The protective reinforcement often comprises two radially superposed protective layers formed of elastic metal reinforcers that are mutually parallel in each layer and are crossed from one layer to the next, forming angles at least equal to 15° with the circumferential direction. The protective layers are radially on the outside of the other crown layers that they protect from attacks.

The working reinforcement, comprising at least two working layers, has the function of belting the tire and conferring stiffness and road holding thereon. It absorbs both mechanical inflation stresses, which are generated by the tire inflation pressure and transmitted by the carcass reinforcement, and mechanical stresses caused by running, which are generated as the tire runs over the ground and are transmitted by the tread. It also needs to withstand oxidation and impacts and perforation, by virtue of its intrinsic design and that of the protective reinforcement.

The working reinforcement usually comprises two radially superposed working layers formed of non-extensible metal reinforcers that are mutually parallel in each layer and are crossed from one layer to the next, forming angles at most equal to 60°, and preferably at least equal to 15° and at most equal to 45°, with the circumferential direction. To reduce shear stresses in the rubber compounds, or rubber mixtures, at the axial ends of the working layers, it is commonplace to axially offset the position of said ends relative to one another. The crown reinforcement therefore usually has a working layer of greater axial width and a working layer of smaller axial width. The shear stresses in the rubber compounds are at their greatest at the end of the working layer of smaller axial width. This is because these maximum shear stresses, owing to the displacement of the end of the working layer of smaller axial width, are distributed over the radial thickness of rubber compounds between the working layer of smaller axial width and the working layer of larger axial width. These shear stresses are amplified by the deformations of the working layer of larger axial width. This is because, given the angle of the metal reinforcers, which are crossed with the metal reinforcers of the working layer of smaller width, the working layer of larger axial width deforms in another direction, thereby increasing the deformation of the rubber compounds. These maximum shear stresses are generally reduced by adding a decoupling rubber between the end of the working layer of smaller axial width and the working layer of larger axial width. The end of the working layer of larger axial width is also subject to high shear stresses which are, however, generally of lesser amplitude given that for this end, the thickness of the rubber compounds is greater and the deformation is no longer amplified by the presence of the other working layer.

In order to reduce the mechanical inflation stresses and stresses caused by running that are transmitted to the working reinforcement and the shear stresses of the rubber compound covering it, it is known practice to dispose a hoop reinforcement radially on the outside of the carcass reinforcement. The hoop reinforcement, the function of which is to at least partially absorb the mechanical inflation stresses, improves the endurance of the crown reinforcement by stiffening the crown reinforcement. The hoop reinforcement can be positioned radially on the inside of the working reinforcement, between the two working layers of the working reinforcement, or radially on the outside of the working reinforcement.

In applications of the construction plant type, the hoop reinforcement may comprise two radially superposed hooping layers formed of metal reinforcers that are mutually parallel in each layer and are crossed from one layer to the next, forming angles at most equal to 10° with the circumferential direction. In order to produce the hooping layers, on tires of construction plant type with a large diameter, the winding of a layer of discontinuous reinforcing elements of which the ends extend from one axial edge of the layer to the other, forming an angle of between 0° and 10° with the circumferential direction, may be preferred to the winding of a narrow strip of several continuous reinforcing elements forming an angle of between 0° and 5° with the circumferential direction, for productivity reasons.

In both cases, the hooping layers have a smaller axial width than the working layer of smaller axial width. This is because the stresses owing to running at the end of the hooping layers are very high in tension and increasing the widths of these hooping layers would adversely affect the endurance of the tire. This avoids disposing reinforcing elements that form angles of between 0° and 10° with the circumferential direction at positions that are axially too far away from the median plane. The document WO2019/202239 discloses a conventional architecture for tires of construction plant type, comprising two hooping layers of stiff reinforcing elements, radially on the inside of two working layers of stiff reinforcing elements radially on the inside of elastic protective layers, the two hooping layers having a substantially smaller axial width than the axial width of the working layers. This document discloses optimizing the protective layers in order to improve the resistance to attacks on the crown to which tires of construction plant type are subjected. Specifically, tires of construction plant type, and particularly those used in surface mines, are subjected to attacks generally in the vicinity of the cutting face where the ore sticks out more. As the tread wears down, the adverse effect that the indentation stiffness of the crown block has on the cuts of the tread is felt. Although the optimization proposed in the prior art has its benefits, the significant circumferential stiffness thereof, mainly provided by the hooping layers, is conducive to the tread becoming cut and unevenly wearing down in the centre, and sometimes the complete perforation of the crown block. It is well known to a person skilled in the art that increasing the mean angle of the hooping plies above 15° makes it possible to decrease the stiffness of the crown, but this accordingly reduces the endurance by promoting cracks at the ends of the working layers.

The inventors set themselves the objective of retaining good endurance, in particular at the ends of the crown layers, and of improving the wear caused by attacks and the resistance to perforation in the centre.

This objective has been achieved, according to the invention, by a radial tire for a vehicle of construction plant type, comprising:
a crown reinforcement, radially on the inside of a tread and radially on the outside of a carcass reinforcement,
a median plane, which is perpendicular to the axis of rotation of the tire and passes through the middle of the tread,
the crown reinforcement comprising at least five layers of metal reinforcing elements, including at least 3 working layers and 2 protective layers radially on the outside of the working layers,
a first, radially innermost working layer, of axial width L1, comprising mutually parallel metal reinforcing elements forming an angle Al at the median plane with the circumferential direction (XX′) tangential to the circumference of the tire,
the second and third working layers radially on the outside of the first working layer, referred to as composite working layers, of respective axial widths L2 and L3,
the composite second and third working layers each comprising 3 parts: a central part and two axial parts positioned on either side of the central part,
the central parts of the composite second and third working layers comprising, over respective axial widths L21 and L31 centred on the median plane, first mutually parallel metal reinforcing elements forming angles A21 and A31, respectively, at the median plane with the circumferential direction (XX′),
the axial parts of the composite second and third working layers, on either side of the central parts, comprising second mutually parallel elastic metal reinforcing elements which have a tensile modulus at most equal to 130 GPa and form angles A22 and A23, respectively, with the circumferential direction (XX′),
two radially outermost protective layers, of axial width LPN1 for the radially innermost protective layer and LPN2 for the radially outermost protective layer, said protective layers comprising mutually parallel elastic metal reinforcers which have a tensile modulus at least equal to 40 GPa and at most equal to 130 GPa, are coated with an elastomeric material and form respectively an angle APN1 for the radially innermost protective layer and APN2 for the radially outermost protective layer with a circumferential direction (XX′), the absolute values of the angles APN1 and APN2 being at least equal to 15°,
the absolute values of the angles at the median plane that are formed by the metal reinforcing elements of the working layers with the circumferential direction (XX′) being at least equal to 20°,
the angles A1 and A31 formed at the median plane by the reinforcing elements of the first layer and third layer, respectively, with the circumferential direction (XX′) having the same sign, this being the opposite sign to the angle A21 formed by the reinforcing elements of the central part of the second working layer at the median plane with the circumferential direction (XX′),
the angles A22 and A32 formed by the elastic reinforcing elements of the axial parts of the second and third working layers with the circumferential direction (XX′) being at most equal to 10°,
the axial width L1 of the first working layer being at least equal to the axial widths L2 and L3 of the second and third working layers, and at least one protective layer having an axial width at least equal to the axial width of the working layer of greater width.

The solution implemented makes it possible to better axially balance the circumferential stiffnesses while still preserving, or even increasing, the stiffness in the vicinity of the axial ends of the working layers and reducing it in the centre. The inventors recognized that the circumferential stiffnesses are too high in the centre owing to the presence of the hooping layers. On certain tires, the hooping layers provide 5 sevenths of the circumferential stiffness in the centre. Counter-intuitively, it is necessary to eliminate the hooping layers in the centre and replace them with working layers that might be classified as composites, the centre of which is formed by first metal reinforcing elements having a stiffness that can be adjusted by way of angles at least equal to 20° and by way of the tensile modulus, and the axial parts of which are formed by second elastic metal reinforcing elements having a tensile modulus at most equal to 130 GPa and an increased stiffness by virtue of the angles less than 8°. Suitable adjustment of the geometry of the crown requires the axial parts of the two composite working layers of which the angles are close to the circumferential direction to be laid on a relatively stiff layer of reinforcing elements, such as a layer of metal reinforcing elements for example, said reinforcing elements being inextensible or otherwise. Were that not the case, during the moulding, the three parts of the composite working layers would have a tendency to arrange themselves differently and create a low-endurance geometry, since their central part deforms more easily than their two axial parts. The solution for the inventors is to dispose the first composite working layer on a first working layer made up, over its entire axial width, of metal reinforcing elements with the restriction that the axial width of this radially innermost working layer is at least equal to the widths of the two composite working layers.

The absence of hooping layers or other crown layers with metal reinforcers forming angles having an absolute value of less than 15° with the circumferential direction, in the centre of the tire, makes the centre of the tire considerably more flexible, and that significantly increases its resistance to abrasion and to perforation. However, this elimination increases the shear stresses at the ends of the working layers and adversely affects the endurance with respect to cracking. This problem is solved by adding reinforcing elements forming angles having an absolute value of less than 10° with the circumferential direction, that are made of metal but are elastic to avoid these reinforcers being subjected to excessive stress by the elevated tension/compression cycles at this location. Elastic is understood here to mean that said metal reinforcing elements have a tensile modulus at most equal to 130 GPa.

This elasticity also makes it possible to correctly mould the crown.

However, for the performance of the tire in terms of endurance by limiting the shear stress at the end notably of the first working layer, which is to say the radially innermost crown layer, it is necessary to have a particular balance between these second elastic metal reinforcing elements and the angles of the reinforcing elements of the first working layer and of the central parts of the second and third working layers, the two latter layers being referred to as composite. As a result, the absolute values of the angles at the median plane that are formed by the metal reinforcing elements of the working layers are at least equal to 20°. Below this value, these working layers will excessively stiffen the crown and will not make it possible to achieve the objective of the invention.

Furthermore, given that the centre of the tire is no longer hooped, it is necessary to couple the centre of the three first working layers. For this, it is necessary for the angles A1 and A31 formed at the median plane by the reinforcing elements of the first layer and third layer, respectively, with the circumferential direction (XX′) to have the same sign, this being the opposite sign to the angle A21 formed by the reinforcing elements of the second layer of reinforcing elements at the median plane with the circumferential direction (XX′). These relative orientations make it possible to give the centre of the tire sufficient stiffness.

Given the presence of hooping reinforcing elements at the axial end of the second and third working layers, it is necessary, taking into account the wear on tires of construction plant type, to protect them against attacks on the crown and thus to dispose at least two protective layers that are the radially outermost crown layers. They have axial widths LPN1 for the radially innermost protective layer and LPN2 for the radially outermost protective layer. These protective layers comprise elastic metal reinforcers for good resistance of the crown to perforation and for not absorbing any of the running tensions, this function being performed by the working layers. These protective layers thus have elastic reinforcing elements with a tensile modulus at least equal to 40 GPa and at most equal to 130 GPa. Their reinforcing elements are, like for the other crown layers, coated with an elastomeric material, mutually parallel and form respectively an angle APN1 for the radially innermost protective layer and APN2 for the radially outermost protective layer with a circumferential direction (XX′), the absolute values of the angles APN1 and APN2 being at least equal to 15°, preferably at least equal to 20°. With such angles, the protective layers having elastic reinforcing elements will not absorb circumferential loads, but above 20° the balance is better, notably as regards the part of the working layers around the median plane.

The presence, in the composite layers towards their axial ends, of metal reinforcing elements that form angles having an absolute value less than 8° with the circumferential direction and are more sensitive than the other parts of the crown layers to breaking in the event of significant circumferential deformation, such as on an attack on the crown when travelling over an obstacle, means it is imperative to protect these parts by way of the protective layers but also the radially innermost working layer. It is thus necessary for at least one protective layer to have an axial width at least equal to the axial width of the working layer of greater width.

A preferred solution for the standardization of the constituent products of the tire is for the reinforcing elements of the central parts of the second and third working layers to be identical, and the same applies for the reinforcing elements of the axial parts of the second and third working layers. However, this standardization is not necessary for the invention to work properly.

To better protect the crown at the ends of the working layers, it is necessary for the protective layer of greater width to be closest to the working layers in order to limit the bending stresses that arise on shocks, such that a preferred solution is for the axial width LPN1 of the radially innermost protective layer to be at least equal to the axial width LPN2 of the radially outermost protective layer.

One solution for the protective layers absorbing few loads caused by running and actually protecting the working layers is for the absolute values of the angles APN1 and APN2 to be at least equal to the maximum absolute values of the angles of the reinforcing elements of the working layers at the median plane, which is to say of all the working layers.

It is advantageous for the angle APN1 formed by the reinforcing elements of the radially innermost protective layer with the circumferential direction (XX′) to have the same sign as the angle formed at the median plane by the reinforcing elements of the radially outermost working layer with the circumferential direction (XX′). This is because any attack causes the compounds of the crown, from the rubber compounds of the tread to the coating compounds of the protective layers, to crack and this causes water from the contact patch to get into the radially innermost protective layer. If the reinforcing elements of the radially innermost protective layer are crossed with those of the radially outermost working layer, for instance at the median plane for a composite or non-composite working layer, the water going from the contact patch towards the reinforcing element of the protective layer and following this reinforcing element is likely to cause corrosion of many consecutive reinforcing elements of the working layer that it crosses. Corrosion of several reinforcing elements close to a working layer greatly weakens the crown. Giving the reinforcing elements of the radially outermost working layer at the median plane and the reinforcing elements of the radially innermost protective layer an orientation with the same sign makes it possible to reduce this risk. Furthermore, this disposition makes it possible to avoid shear stresses in the rubber compositions between the radially outermost working layer and the radially innermost protective layer.

It is also preferable for the angle APN1 formed by the reinforcing elements of the radially innermost protective layer with the circumferential direction (XX′) to have the opposite sign to the angle APN2 formed by the reinforcing elements of the radially outermost protective layer with the circumferential direction (XX′) in order to homogenize, in all directions, the resistance of the crown to attacks and thus improve the resistance of the crown to shocks.

It is advantageous for the absolute value of the angle Al formed by the reinforcing elements of the first working layer with the circumferential direction (XX′) to be at most equal to the absolute values of the angles A21 and A31 formed at the median plane by the first reinforcing elements of the central parts of the second working layer and of the third working layer, respectively, with the circumferential direction (XX′). This configuration makes it possible to avoid an excessive proportion of the circumferential loads being absorbed by the elastic reinforcing elements of the axial parts of the second and third working layers. This allows a good balance between the drop in stiffness in the centre, which requires angles of the reinforcing elements of the working layers in the centre to be at least equal to 20° and more if possible, and an acceptable value for tensions in the axial parts, in the elastic reinforcing elements of the second and third working layers. The reinforcing elements of the first working layer absorb more circumferential tension with a smaller angle. It is advantageous for the difference, in terms of absolute value, between the mean of the absolute values of the angles of the reinforcing elements of the central parts of the second and third working layers with the circumferential direction and the absolute value of the angle of the reinforcing elements of the radially innermost working layer to be at least equal to 2°, preferably at least equal to 4°.

One advantageous solution is for the reinforcing elements of the first working layer and of the central parts of the composite second and third working layers to be inextensible, their tensile modulus being at least equal to 150 GPa. As a result, these parts absorb a large proportion of the running loads and allow good endurance of the crown and notably of the axial parts of the second and third working layers.

A preferred solution is for the axial width L21 of the central part of the second working layer to be at least equal to the axial width L31 of the central part of the third working layer. Specifically, the closer the axial zone of the composite layer is to the tread, the greater the bending loads absorbed by its reinforcing elements will be, and it is thus necessary, to reduce the loads in the reinforcing elements of the axial part of the third working layer, for it to be axially further to the inside than the axial part of the second working layer.

Furthermore, an advantageous solution is for the difference between the axial widths L21 and L31 of the central parts of the second and third working layers comprising inextensible first metal reinforcing elements to be at least equal to four times the diameter of the inextensible reinforcing elements of the second working layer. This is because the transition from the central zone of the working layers to the axial zone creates a considerable difference in stiffness, notably bending. It is risky to concentrate this difference at a single axial position. Concentrating this difference at a single axial position for the two composite working layers would contribute to concentrating the bending deformations caused by the tire being crushed in this zone, running the risk of creating fatigue ruptures in the reinforcing elements of the other crown layers, these ruptures possibly leading to a defect caused by a circumferential cut in the crown. The proposed axial offset of the axial ends of the central parts of the second and third working layers is enough to avoid this problem, taking account of the dimensions of the reinforcing elements for such applications.

A preferred solution is for the elastic reinforcing elements of the axial parts of the second and third working layers to be formed by circumferentially winding a continuous strip of the second layer around the third working layer, said strip comprising at least 1 and at most 5 elastic reinforcing elements. Said strip comprises circumferential ends, said circumferential ends being optimally situated at the axial ends of the central parts of the second and third working layers. The advantage of a strip is to improve the laying rate of the axial parts of the composite working layers. It is still possible to lay a bare cord, and this is a feasible solution, but laying a strip composed of a cord (or reinforcing elements) surrounded by a rubber composition is preferable to avoid creating circumferential recesses which could possibly become filled with water and cause corrosion of the reinforcing elements of the various working layers. A strip composed of several reinforcing elements is also advantageous since it reduces the time needed to lay the axial parts in proportion to the number of reinforcing elements. This possibility is, however, limited because the ends of such a strip, even bevelled, create a zone of weakness in the crown, this weakness being all the more pronounced the wider the strip is. A very advantageous solution is for the same strip to create one of the two axial parts of the second working layer and then, without discontinuity, the axial part radially on the outside thereof of the third working layer. This makes it possible to avoid the presence of a cord end at the axial ends of the second and third working layers which are then zones of weakness where the elastic reinforcing elements are subjected to the most stress. To improve productivity, it is possible to lay such strips on either side of the central parts at the same time.

The best balance in terms of performance was obtained when the elastic reinforcing elements of the axial parts of the second and third working layers have a tensile modulus at least equal to 80 GPa and a structural elongation at least equal to 0.3%.

One preferred solution comprises 4 working layers, the axially outermost fourth working layer of axial width L4 comprising mutually parallel inextensible metal reinforcing elements which have a tensile modulus at least equal to 150 GPa and form an angle A4 at the median plane with the circumferential direction (XX′) tangential to the circumference of the tire, said axial width LA being at least equal to the axial widths L2 and L3 of the second and third working layers and less than the axial width L1 of the first working layer, said angle A4 having the opposite sign to the angle Al formed by the reinforcing elements of the first working layer with the circumferential direction (XX′) and having an absolute value at least equal to 20°, preferably at least equal to the absolute values of the angles A21 and A31 formed at the median plane by the inextensible first reinforcing elements of the central parts of the second working layer and of the third working layer, respectively, with the circumferential direction (XX′). This version is the most optimized one in relation to the performance of the crowns of the best-performing tires of construction plant type that are sold on the market and comprise two central hooping layers, two working layers and two protective layers. They have equivalent masses.

In an improved version, the absolute value of the angle formed by the reinforcing elements of the fourth working layer with the circumferential direction (XX′) is less than the absolute values of the angles A21 and A31 formed at the median plane by the inextensible first reinforcing elements of the central parts of the second working layer and of the third working layer, respectively, with the circumferential direction (XX′) and preferably is equal to the absolute value of the angle A1 formed at the median plane by the inextensible reinforcing elements of the first working layer, give or take manufacturing variations. The aim of this, like for the angle of the first working layer, is to avoid the elastic reinforcing elements of the axial parts of the second and third working layers absorbing excessive circumferential tensions. In the same way, the difference, in terms of absolute value, between the mean of the absolute values of the angles of the inextensible reinforcing elements of the central part of the second and third working layers with the circumferential direction and the absolute value of the angle of the reinforcing elements of the radially outermost fourth working layer is at least equal to 2°, preferably at least equal to 4°.

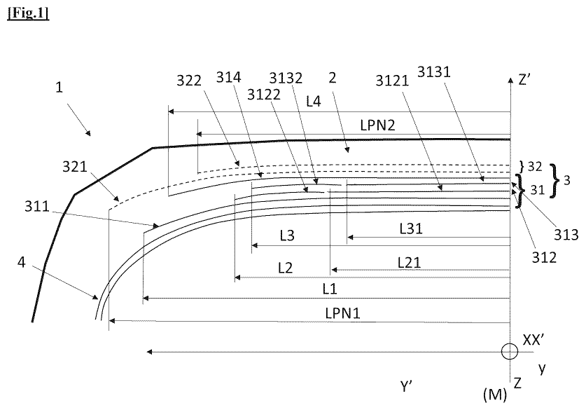

The characteristics of the invention are illustrated schematically and not to scale in FIG. 1, with reference to a tire of size 24.00R35: FIG. 1 shows a meridian section through a crown of a tire according to the invention.

FIG. 1 shows a meridian section through a tire 1 for a heavy-duty vehicle of construction plant type, comprising a crown reinforcement 3 radially on the inside of a tread 2 and radially on the outside of a carcass reinforcement 4. The crown reinforcement 3 comprises, radially from the outside to the inside, a protective reinforcement 32 and a working reinforcement 31. The protective reinforcement 32 comprises two protective layers (321, 322) of respective axial widths LPN1 and LPN2, comprising elastic metal reinforcers that are coated in an elastomeric material, are mutually parallel and form respective angles APN1 and APN2 with a circumferential direction XX′ tangential to the circumference of the tire at the median plane, the respective metal reinforcers of each protective layer being crossed from one protective layer to the next. The working reinforcement 32 in the present case comprises four working layers 311, 312, 313, 314, including two composite working layers 312, 313 between two non-composite working layers 311 and 314, the respective metal reinforcers of which are coated with an elastomeric material, are mutually parallel and form respective angles Al and A4, measured at the median plane, with the circumferential direction XX′, said reinforcing elements being continuous over their respective axial widths L1 and L4. A version without the fourth working layer is possible, but is not shown here. The version with four working layers is the solution exhibiting best performance. The two composite working layers, i.e. the second and third working layers, of respective axial widths L2 and L3 each comprise 3 parts: a central part 3121, 3131, respectively, and two axial parts on either side of the central part, the figure showing only the left-hand axial parts 3122, 3123. The central parts 3121, 3131 of the composite second and third working layers (312, 313) comprise, over respective axial widths L21 and L31 centred on the median plane (M), first metal reinforcing elements forming angles A21 and A31, respectively, at the median plane with the circumferential direction (XX′). The axial parts 3122, 3132 of the composite second and third working layers 312, 313, on either side of the central parts 3121, 3131, comprise elastic metal reinforcing elements that form angles A22 and A23, respectively, with the circumferential direction (XX′).

The angles APN1, APN2, A1, A21, A22, A31, A32, A4 are not shown in the figure. A person skilled in the art will know to measure these angles on a tire either using non-destructive testing means or by cutting the tire open and accessing the various crown layers. The same applies for the measurement of the axial widths of the various crown layers, which are usually measured on a meridian section. The angles are preferably measured in the centre of the crown layer in question—usually at the median plane—or in the centre of the axial part in question to afford a reference value, the measured angle possibly varying slightly with the axial position at which the measurement was taken. The axial width L1 of the first working layer 311 is at least equal to the axial widths L2 and L3 of the second and third working layers 312, 313, and at least one protective layer, in this case the radially innermost protective layer 321, has an axial width LPN1 at least equal to the axial width of the working layer of greater width, in this case the radially innermost working layer 311. In FIG. 1, the axial width L21 of the central part 3121 of the second working layer 312 is at least equal to the axial width L31 of the central part 3131 of the third working layer 313.

The invention has been tested on a 24.00R35 tire, the crown of which has 4 working layers, two of which-the second and the third-being composite. The first and the fourth are composed of inextensible reinforcing elements in a 26×30 configuration comprising twenty-six steel threads with a diameter of thirty hundredths of a millimetre for a tensile modulus, measured on a cord removed from the tire, equal to 160 GPa, the reinforcing elements being disposed at a pitch of 3.4 mm and forming respective angles A1 and A4 equal to 24° and −24° at the median plane with the direction. The central parts 3121 and 3131 of the composite working layers also comprise inextensible reinforcing elements in a 26×30 configuration comprising twenty-six steel threads with a diameter of thirty hundredths of a millimetre for the same tensile modulus and disposed at a pitch of 3.4 mm, the angles A21 and A31 formed by the reinforcing elements with the circumferential direction at the median plane being equal to −28° and 28°, respectively. The axial parts of the second and third working layers, which are composite working layers, comprise elastic reinforcing elements in a 44×35 configuration, for a tensile modulus, measured on a cord removed from the tire, equal to 90 GPa, and a structural elongation equal to 0.6%, the reinforcing elements being disposed at a pitch of 4.4 mm and forming respective angles A22 and A32 equal to 2° and −2° at the median plane with the direction. The axial parts are produced by winding a continuous strip of 1 cord from the axial end of the central part 3121 to the axial end of the axial part of the second layer, and then back to the axial end of the central part of the third working layer. The crown layers also comprise two protective layers 321 and 322, made up of elastic reinforcing elements in a 24×26 configuration, which is to say twenty-four steel threads with a diameter of 26 hundredths of a millimetre, for a tensile modulus, measured on a cord removed from the tire, equal to 60 GPa, and a structural elongation equal to 0.6%, the reinforcing elements being disposed at a pitch of 4.4 mm and forming respective angles APN1 and APN2 equal to 33° and −33 ° at the median plane with the direction. The first working layer has an axial width of 444 mm. The second working layer has an axial width of 360 mm and its central part has an axial width of 250 mm. The third working layer has an axial width of 340 mm and its central part has an axial width of 200 mm. The fourth working layer has an axial width of 402 mm. The radially innermost protective layer has an axial width of 524 mm. The radially outermost protective layer has an axial width of 360 mm.

The invention is compared with a commercially available control tire (“Michelin XTRA Load Protect E4B*** ”) of the same size, the crown of which is composed of two hooping layers radially on the inside of two working layers radially on the inside of two protective layers. The reinforcing elements of the hooping layers form angles of 8 and −8°. They are inextensible and have a 26×30 configuration, which is to say 26 steel threads with a diameter of 30 hundredths of a millimetre, for a tensile modulus, measured on a cord removed from the tire, equal to 160 GPa, and are disposed at a pitch of 3.4 mm. The reinforcing elements of the working layers form angles of 33° and −19°. They are inextensible and identical to the reinforcing elements of the first (and the fourth) working layer of the invention. The reinforcing elements of the protective layers form angles of 24° and −24°. They are elastic and identical to the reinforcing elements of the protective layers of the invention. The hooping layers have an axial width of 240 mm for the radially innermost one and 200 mm for the radially outermost one, it not being possible to increase this axial width without running the risk of these reinforcing elements breaking. The first working layer has an axial width of 450 mm. The second working layer has an axial width of 380 mm. The radially innermost protective layer has an axial width of 520 mm. The radially outermost protective layer has an axial width of 400 mm. More specifically, the inextensible metal reinforcers in a 26×30 configuration, which is to say cords of 26 threads with a diameter of 30 hundredths of a mm, are disposed in three layers with the central layer comprising 3 threads, the second comprising 9 threads and the outer layer comprising 14 threads. The elastic metal reinforcers of the protective reinforcement of the control tire are cords in a 24×26 configuration, which is to say strands of 4 cords of 6 threads with a diameter of 26 hundredths of a mm.

The control tire and the tire according to the invention are identical apart from the crown reinforcement. They have the same tread pattern and the same reinforcers for the carcass layer and the same rubber compounds for the various parts of the tires.

The invention has been simulated on calculation tools and is tested on tires of size 24.00R35. The simulations make it possible to evaluate the mechanical and thermal stresses exerted on tires using the finite element method for large displacement and large strain, taking into account the mechanical and hysteretic properties of the materials.

The aim of the invention is to reduce the circumferential stiffness in the centre in order to improve wear and resistance to attacks and perforations. The drop in stiffness is estimated from the deformation of the crown block under the effect of a pressure increase. The stiffness in the centre of the crown is reduced fourfold, while the stiffness at the ends of the crown layers sees a twofold to fourfold increase. The invention exhibits a very even stiffness of the crown over an area of approximately 360 mm of axial width, varying approximately by 25% over this area, while the control tire exhibits an approximately 20-fold variance between the minimum and maximum. This drop in stiffness in the centre should give the invention approximately 20% better resistance to perforation and should solve problems of uneven wear owing to the excessive stiffness of the centre of the control tire.

With respect to the endurance of the crown, the safety coefficients (breaking strength of the cord when subjected to maximum stresses) of the reinforcing elements of all of the crown layers are at least equal to the minimum safety coefficient of the control tire. Similarly, the stresses in the rubber compositions at the ends of the working layers are improved by virtue of the axial parts of the composite working layers. From this perspective, the inventors expect a performance in terms of endurance which is at least the same as, if not better than, the crown. The masses of the control tire and of the tire according to the invention are equivalent.

All of these performance aspects demonstrate the benefit of the invention.

1. A radial for a vehicle of construction plant type, comprising:
a crown reinforcement, radially on the inside of a tread and radially on the outside of a carcass reinforcement,
a median plane (M), which is perpendicular to the axis of rotation of the tire and passes through the middle of the tread,
the crown reinforcement comprising at least five layers of metal reinforcing elements, including at least 3 working layers and 2 protective layers radially on the outside of the working layers,
a first, radially innermost working layer, of axial width L1, comprising mutually parallel metal reinforcing elements forming an angle A1 at the median plane with the circumferential direction (XX′) tangential to the circumference of the tire,
a second and a third working layer radially on the outside of the first working layer, referred to as composite working layers, of respective axial widths L2 and L3,
the composite second working layer and third working layer each comprising 3 parts: a central part; and two axial parts positioned on either side of the central part,
the central parts of the composite second and third working layers comprising, over respective axial widths L21 and L31 centred on the median plane (M), first mutually parallel metal reinforcing elements forming angles A21 and A31, respectively, at the median plane with the circumferential direction (XX′),
the axial parts of the composite second and third working layers, on either side of the central parts, comprising second mutually parallel elastic metal reinforcing elements which have a tensile modulus at most equal to 130 GPa and form angles A22 and A23, respectively, with the circumferential direction (XX′),
two radially outermost protective layers, of axial width LPN1 for the radially innermost protective layer and LPN2 for the radially outermost protective layer, said protective layers comprising mutually parallel elastic metal reinforcers which have a tensile modulus at least equal to 40 GPa and at most equal to 130 GPa, are coated with an elastomeric material and form respectively an angle APN1 for the radially innermost protective layer and APN2 for the radially outermost protective layer with a circumferential direction (XX′), the absolute values of the angles APN1 and APN2 being at least equal to 15°,
wherein the absolute values of the angles A1, A21, A31 at the median plane that are formed by the metal reinforcing elements of the working layers with the circumferential direction (XX′) are at least equal to 20°,
wherein the angles A1 and A31 formed at the median plane by the reinforcing elements of the first layer and third layer, respectively, with the circumferential direction (XX′) have the same sign, this being the opposite sign to the angle A21 formed by the reinforcing elements of the central part of the second working layer at the median plane with the circumferential direction (XX′),
wherein the angles A22 and A32 formed by the elastic reinforcing elements of the axial parts of the second and third working layers with the circumferential direction (XX′) are at most equal to 8°, and
wherein the axial width L1 of the first working layer is at least equal to the axial widths L2 and L3 of the second and third working layers, and at least one protective layer has an axial width LPN1, LPN2 at least equal to the axial width of the working layer of greater width.

2. The tire according to claim 1, wherein the axial width LPN1 of the radially innermost protective layer is at least equal to the axial width LPN2 of the radially outermost protective layer.

3. The tire according to claim 1, wherein the absolute values of the angles APN1 and APN2 are at least equal to the maximum absolute values of the angles A1, A21, A31 of the reinforcing elements of the working layers at the median plane, the angle APN1 formed by the reinforcing elements of the radially innermost protective layer with the circumferential direction (XX′) having the same sign as the angle formed at the median plane by the reinforcing elements of the radially outermost working layer with the circumferential direction (XX′) and the opposite sign to the angle APN2 formed by the reinforcing elements of the radially outermost protective layer with the circumferential direction (XX′).

4. The tire according to claim 1, wherein the absolute value of the angle A1 formed by the reinforcing elements of the first working layer with the circumferential direction (XX′) is at most equal to the absolute values of the angles A21 and A31 formed at the median plane by the first reinforcing elements of the central parts of the second working layer and of the third working layer respectively, with the circumferential direction (XX′).

5. The tire according to claim 1, wherein the reinforcing elements of the first working layer and of the central parts of the composite second and third working layers are inextensible, their tensile modulus being at least equal to 150 GPa.

6. The tire according to claim 1, wherein the axial width L21 of the central part of the second working layer is at least equal to the axial width L31 of the central part of the third working layer.

7. The tire according to claim 1, wherein the difference between the axial widths L21 and L31 of the central parts of the second and third working layers comprising first metal reinforcing elements is at least equal to four times the diameter of the inextensible reinforcing elements of the second working layer.

8. The tire according to claim 1, wherein the second elastic reinforcing elements of the axial parts of the second and third working layers are formed by circumferentially winding a continuous strip of the second layer around the third working layer, said strip comprising at least 1 and at most 5 elastic reinforcing elements, said strip comprising circumferential ends, said circumferential ends being situated at the axial ends of the central parts of the second and third working layers.

9. The tire according to claim 1, wherein the second elastic reinforcing elements of the axial parts of the second and third working layers have a tensile modulus at least equal to 80 GPa and a structural elongation at least equal to 0.3%.

10. The tire according to claim 1. comprising 4 working layers, wherein the axially outermost fourth working layer of axial width L4 comprises mutually parallel inextensible metal reinforcing elements which have a tensile modulus at least equal to 150 GPa and form an angle A4 at the median plane with the circumferential direction (XX′) tangential to the circumference of the tire, said axial width L4 being greater than the axial widths L2 and L3 of the second and third working layers and less than the axial width L1 of the first working layer, said angle A4 having the opposite sign to the angle A1 formed at the median plane by the reinforcing elements of the first working layer with the circumferential direction (XX′) and having an absolute value at least equal to 20°.

11. The tire according to claim 10, wherein the absolute value of the angle formed by the reinforcing elements of the fourth working layer with the circumferential direction (XX′) is less than the absolute values of the angles A21 and A31 formed at the median plane by the inextensible first reinforcing elements of the central parts of the second working layer and of the third working layer, respectively, with the circumferential direction (XX′) and preferably is equal to the absolute value of the angle A1 formed at the median plane by the inextensible reinforcing elements of the first working layer.
